(19) United States
(12) Patent Application Publication
(10) Pub. No.: US 2024/0396071 A1
(43) Pub. Date: Nov. 28, 2024

(54) METHOD FOR MANUFACTURING ELECTRODE ASSEMBLY

(71) Applicant: TOYOTA JIDOSHA KABUSHIKI KAISHA, Toyota-shi (JP)

(72) Inventors: Yusuke Ikeda, Miyoshi-shi (JP); Kazuhito Kato, Toyota-shi (JP); Takaaki Goto, Seto-shi (JP); Masayoshi Haga, Nagoya-shi (JP); Minehiro Funato, Toyota-shi (JP); Tsuyoshi Kaneko, Nisshin-shi (JP); Yuka Yokoi, Nagoya-shi (JP)

(73) Assignee: TOYOTA JIDOSHA KABUSHIKI KAISHA, Toyota-shi (JP)

(21) Appl. No.: 18/649,064

(22) Filed: Apr. 29, 2024

(30) Foreign Application Priority Data
May 25, 2023 (JP) 2023-086242

(51) Int. Cl. H01M 10/04; H01M 50/406; H01M 50/414; H01M 50/466

(52) U.S. Cl. CPC H01M 10/0413; H01M 50/406; H01M 50/414; H01M 50/466

(57) ABSTRACT

A method for manufacturing an electrode assembly includes: a stacking step of stacking a plurality of positive electrode units and a plurality of negative electrodes such that the positive electrode units alternate respectively with the negative electrodes, each positive electrode unit including a first resin portion, a second resin portion, a positive electrode, and a bag separator; a first cutting step of cutting a plurality of the first resin portions together with the bag separator along a stacking direction; a second cutting step of cutting a plurality of the second resin portions together with the bag separator along the stacking direction; a first welding step of welding together a pair of the first resin portions adjacent to each other in the stacking direction; and a second welding step of welding together a pair of the second resin portions adjacent to each other in the stacking direction.

### CROSS REFERENCE TO RELATED APPLICATIONS

This nonprovisional application is based on Japanese Patent Application No. 2023-086242 filed on May 25, 2023 with the Japan Patent Office, the entire contents of which are hereby incorporated by reference.

### BACKGROUND

### Field

The present disclosure relates to a method for manufacturing an electrode assembly.

### Description of the Background Art

WO 2018/021263 discloses a method for manufacturing an electrode assembly in which a stack in which a first separator and a second separator are bonded to both surfaces of a negative electrode sheet, and a positive electrode sheet, are alternately stacked to form an electrode assembly.

### SUMMARY

In the method for manufacturing the electrode assembly described in WO 2018/021263, after the electrode assembly is formed, the stack and the positive electrode sheet may be displaced from each other in a direction orthogonal to the stacking direction.

It is an object of the present disclosure to provide a method for manufacturing an electrode assembly that enables suppression of displacement of a positive electrode and a negative electrode from each other in a direction orthogonal to a stacking direction.

A method for manufacturing an electrode assembly according to an aspect of the present disclosure includes: a stacking step of stacking a plurality of positive electrode units and a plurality of negative electrodes such that the positive electrode units alternate respectively with the negative electrodes, each of the plurality of positive electrode units including: a first resin portion; a second resin portion; a positive electrode located between the first resin portion and the second resin portion; and a bag separator formed in a bag shape with an opening and holding the first resin portion, the second resin portion, and the positive electrode in the bag separator; a first cutting step of cutting a plurality of the first resin portions together with the bag separator along a stacking direction in which the positive electrode units and the negative electrodes are stacked, the plurality of the first resin portions being arranged in the stacking direction; a second cutting step of cutting a plurality of the second resin portions together with the bag separator along the stacking direction, the plurality of the second resin portions being arranged in the stacking direction; a first welding step of welding together a pair of the first resin portions adjacent to each other in the stacking direction, among the plurality of the first resin portions; and a second welding step of welding together a pair of the second resin portions adjacent to each other in the stacking direction, among the plurality of the second resin portions.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage cell according to an embodiment of the present disclosure.

FIG. 2 is a cross-sectional view of the power storage cell shown in FIG. 1.

FIG. 3 is a diagram schematically showing a method for manufacturing an electrode assembly.

FIG. 4 is a diagram schematically showing the method for manufacturing an electrode assembly.

FIG. 5 is a diagram schematically showing the method for manufacturing an electrode assembly.

### DESCRIPTION OF THE PREFERRED EMBODIMENTS

Embodiments of the present disclosure will be described with reference to the drawings. In the drawings referred to below, the same or corresponding members are denoted by the same reference numerals.

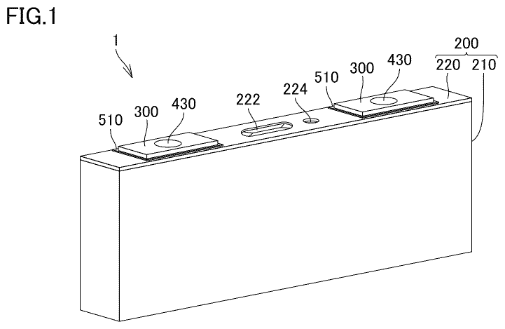

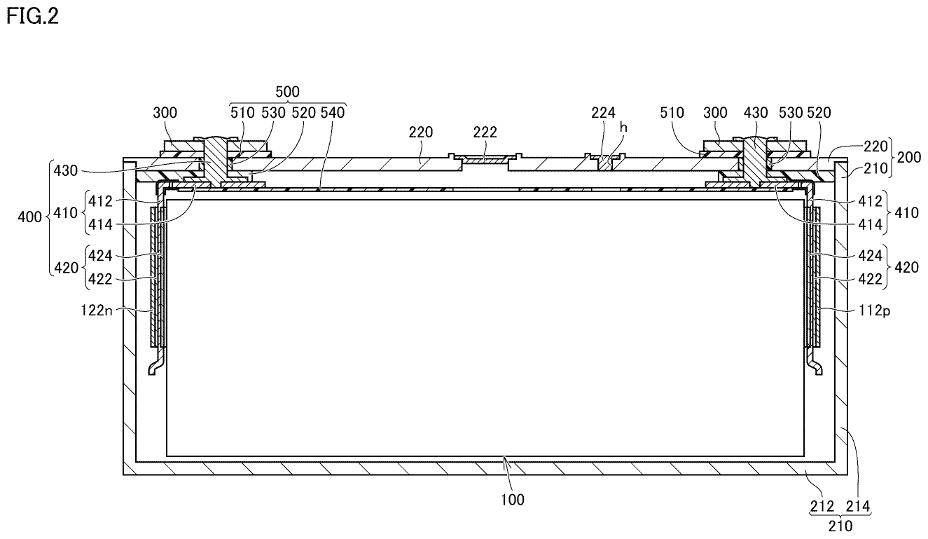

FIG. 1 is a perspective view schematically showing a power storage cell according to an embodiment of the present disclosure. FIG. 2 is a cross-sectional view of the power storage cell shown in FIG. 1.

As shown in FIGS. 1 and 2, the power storage cell 1 includes an electrode assembly 100, a cell case 200, a pair of external terminals 300, a pair of connecting members 400, and an insulating member 500.

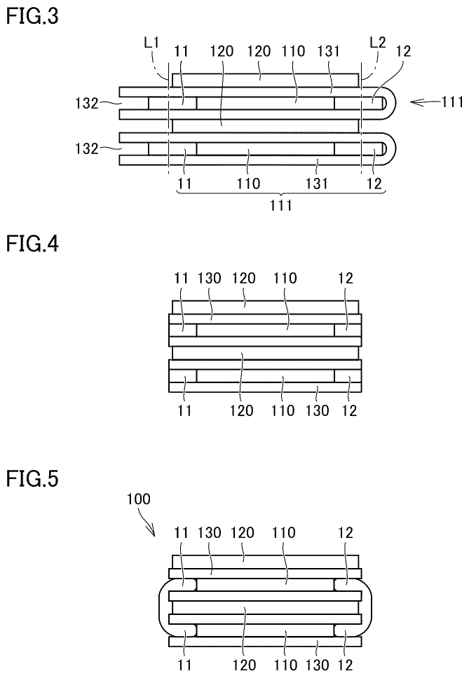

The electrode assembly 100 includes a plurality of electrodes 110 and 120 (see FIGS. 3 to 5), and a separator 130.

The plurality of electrodes 110 and 120 are arranged side by side in one direction (a direction orthogonal to the plane of FIG. 2). The plurality of electrodes 110 and 120 have a plurality of positive electrodes 110 and a plurality of negative electrodes 120.

Each positive electrode 110 is formed in a rectangular shape elongated in the width direction (direction orthogonal to both one direction and the vertical direction). Each positive electrode 110 includes a positive electrode current collector foil and positive electrode active material layers provided on both surfaces of the positive electrode current collector foil. As shown in FIG. 2, the positive electrode current collector foil has a positive electrode tab 112p having no positive electrode active material layer. The positive electrode tab 112p protrudes toward one side in the width direction.

Each negative electrode 120 is formed in a rectangular shape elongated in the width direction. Each negative electrode 120 includes a negative electrode current collector foil and a negative electrode active material layer provided on both surfaces of the negative electrode current collector foil. As shown in FIG. 2, the negative electrode current collector foil has a negative electrode tab 122n having no negative electrode active material layer. The negative electrode tab 122n protrudes toward the other side in the width direction.

The separator 130 insulates the positive electrode 110 from the negative electrode 120. The separator 130 is made of an insulating material, and has minute voids that allow penetration of ions.

The cell case 200 houses the electrode assembly 100. The cell case 200 contains an electrolytic solution (not shown). The cell case 200 is sealed. The cell case 200 includes a case body 210 and a lid 220.

The case body 210 has an opening that opens upward. The case body 210 is made of metal such as aluminum. As shown in FIG. 2, the case body 210 includes a bottom wall 212 and a peripheral wall 214. The bottom wall 212 is formed in a rectangular and flat plate shape. The peripheral wall 214 rises from the bottom wall 212. The peripheral wall 214 is formed in a quadrangular cylindrical shape. The length of the peripheral wall 214 in the width direction is longer than the length of the peripheral wall 214 in the thickness direction. The length of the peripheral wall 214 in the height direction is longer than the length of the peripheral wall 214 in the thickness direction.

The lid 220 closes the opening of the case body 210. The lid 220 is connected to the opening by welding or the like. The lid 220 is formed in a flat plate shape. The lid 220 is made of metal such as aluminum. The lid 220 includes a pressure release valve 222 and a sealing member 224.

The pressure release valve 222 is formed at the center of the lid 220. The pressure release valve 222 is formed so as to break when the internal pressure of the cell case 200 becomes equal to or higher than a predetermined pressure. When the pressure release valve 222 breaks, the gas in the cell case 200 is released to the outside of the cell case 200 through the pressure release valve 222, so that the internal pressure of the cell case 200 decreases.

The sealing member 224 seals the liquid injection port h formed in the lid 220. The liquid injection port h is a through hole for injecting the electrolytic solution into the cell case 200 in the manufacturing process of the power storage cell 1. After the electrolytic solution is injected into the case body 210 through the liquid injection port h, the liquid injection port h is sealed by the sealing member 224.

The pair of external terminals 300 is fixed on the cell case 200. One of the pair of external terminals 300 is a positive electrode external terminal and the other is a negative electrode external terminal. Each external terminal 300 is fixed to the upper surface of the lid 220 via an upper insulating portion 510 described later. Each external terminal 300 is made of a metal such as aluminum. Each external terminal 300 is formed, for example, in a rectangular parallelepiped shape. A bus bar (not shown) is connected to each external terminal 300 by welding or the like.

The pair of connecting members 400 connects the plurality of electrode tabs 112p and 122n to the external terminal 300. One of the connecting members 400 connects the plurality of positive electrode tabs 112p and the positive electrode external terminal 300, and the other connecting member 400 connects the plurality of negative electrode tabs 122n and the negative electrode external terminal 300. Since each of the pair of connecting members 400 has substantially the same structure, one of the connecting members 400 will be described below.

The connecting member 400 includes a current collector tab 410, a sub-tab 420, and a connecting pin 430.

The current collector tab 410 has a lateral portion 412 and an upper portion 414. The lateral portion 412 is positioned on the lateral side of the electrode assembly 100 in the width direction. The upper portion 414 is positioned above the electrode assembly 100. The upper portion 414 extends inward in the width direction from the upper end of the lateral portion 412.

The sub tab 420 connects the plurality of positive electrode tabs 112p to the current collector tab 410. One end 422 of the sub tab 420 is connected to the plurality of positive electrode tabs 112p by welding or the like, and the other end 424 of the sub tab 420 is connected to the lateral portion 412 of the current collector tab 410 by welding or the like.

The connecting pin 430 connects the current collector tab 410 and the external terminal 300. The connecting pin 430 connects the upper portion 414 and the external terminal 300. Specifically, the lower end portion of the connecting pin 430 is connected to the upper portion 414 by welding or the like in a state of being inserted into a through hole provided in the upper portion 414, and the upper end portion of the connecting pin 430 is connected to the external terminal 300 by welding, caulking or the like in a state of being inserted into a through hole provided in the external terminal 300.

The insulating member 500 insulates the cell case 200 from the connecting member 400. The insulating member 500 includes an upper insulating portion 510, a lower insulating portion 520, an insulator 530, and an insulating plate 540.

The upper insulating portion 510 is fixed to the upper surface of the lid 220. The upper insulating portion 510 is disposed between the lid 220 and the external terminal 300. The upper insulating portion 510 is provided with an insertion hole through which the connecting pin 430 is inserted.

The lower insulating portion 520 is fixed to the lower surface of the lid 220. The lower insulating portion 520 is disposed between the lid 220 and the lower portion of the upper portion 414 and the connecting pin 430. The lower insulating portion 520 is provided with an insertion hole through which the connecting pin 430 is inserted.

The insulator 530 is disposed between the connecting pin 430 and the lid 220. The insulator 530 is formed in a cylindrical shape and surrounds the connecting pin 430.

The insulating plate 540 is fixed to the lower surface of the upper portion 414. The insulating plate 540 is disposed above the electrode assembly 100. A through hole is formed in a portion of the insulating plate 540 located below the pressure release valve 222 and a portion of the insulating plate 540 located below the liquid injection port h.

Next, a manufacturing process of the electrode assembly 100 will be described with reference to FIGS. 3 to 5. The method for manufacturing the electrode assembly 100 includes a stacking step, a first cutting step, a second cutting step, a first welding step, and a second welding step.

In the stacking step, a plurality of positive electrode units 111 and a plurality of negative electrodes 120 are alternately stacked. As shown in FIG. 3, each positive electrode unit 111 includes a first resin portion 11, a second resin portion 12, a positive electrode 110, and a bag separator 131. FIG. 3 shows a state after the stacking step.

The first resin portion 11 and the second resin portion 12 may be formed of the same resin or different resins. The length of each of the resin portions 11 and 12 in the arrangement direction (the lateral direction in FIG. 3) of the first resin portion 11 and the second resin portion 12 is shorter than the length of the positive electrode 110 in the arrangement direction. The thickness of each of the resin portions 11 and 12 is equal to or smaller than the thickness of the positive electrode 110.

The positive electrode 110 is disposed between the first resin portion 11 and the second resin portion 12. The end portions of the positive electrode 110 in the arrangement direction may contact or be separated from the resin portions 11 and 12. The bag separator 131 is formed in a bag shape having an opening 132. The bag separator 131 houses the first resin portion 11, the second resin portion 12, and the positive electrode 110 such that the positive electrode 110 is disposed between the first resin portion 11 and the second resin portion 12. The second resin portion 12 is preferably in contact with the folded portion of the bag separator 131 so that the second resin portion 12 is positioned with respect to the bag separator 131.

In the first cutting step, the plurality of first resin portions 11 arranged in the stacking direction of the positive electrode unit 111 and the negative electrode 120 are cut together with the bag separator 131 along the stacking direction. In FIG. 3, a portion to be cut in the first cutting step is indicated by a chain line L1.

In the second cutting step, the plurality of second resin portions 12 arranged in the stacking direction are cut together with the bag separator 131 along the stacking direction. In FIG. 3, the portion cut in the second cutting step is indicated by a chain line L2. FIG. 4 shows a state after the first cutting step and the second cutting step. The separator 130 is formed by the bag separator 131 passing through the first cutting step and the second cutting step.

In the first welding step, the pair of first resin portions 11 adjacent to each other in the stacking direction among the plurality of first resin portions 11 are welded to each other. In the first welding step, the pair of first resin portions 11 is heated by a heating means (not shown). Thereby, the melted first resin portions 11 are welded to each other. In the first welding step, the pair of first resin portions 11 are welded so that the first resin portions 11 contact the negative electrode 120 positioned between the pair of first resin portions 11.

In the second welding step, the pair of second resin portions 12 adjacent to each other in the stacking direction among the plurality of second resin portions 12 are welded to each other. In the second welding step, the second resin portion 12 is heated in the same manner as in the first welding step. In the second welding step, the pair of second resin portions 12 are welded so that the second resin portions 12 contact the negative electrode 120 positioned between the pair of second resin portions 12. FIG. 5 shows a state after the first welding step and the second welding step.

As described above, in the manufacturing method for the electrode assembly 100 according to the present embodiment, the first resin portion 11, the positive electrode 110, and the second resin portion 12 are effectively positioned by using the bag separator 131, and the pair of first resin portions 11 and the pair of second resin portions 12 are welded to each other so as to sandwich the negative electrode 120 in the stacking direction, so that the positive electrode 110 and the negative electrode 120 are prevented from being displaced from each other in the direction orthogonal to the stacking direction.

It will be appreciated by those skilled in the art that the exemplary embodiments described above are specific examples of the following aspects.

### [Aspect 1]

A method for manufacturing an electrode assembly, the method comprising:
a stacking step of stacking a plurality of positive electrode units and a plurality of negative electrodes such that the positive electrode units alternate respectively with the negative electrodes, each of the plurality of positive electrode units including: a first resin portion; a second resin portion; a positive electrode located between the first resin portion and the second resin portion; and a bag separator formed in a bag shape with an opening and holding the first resin portion, the second resin portion, and the positive electrode in the bag separator;
a first cutting step of cutting a plurality of the first resin portions together with the bag separator along a stacking direction in which the positive electrode units and the negative electrodes are stacked, the plurality of the first resin portions being arranged in the stacking direction;
a second cutting step of cutting a plurality of the second resin portions together with the bag separator along the stacking direction, the plurality of the second resin portions being arranged in the stacking direction;
a first welding step of welding together a pair of the first resin portions adjacent to each other in the stacking direction, among the plurality of the first resin portions; and
a second welding step of welding together a pair of the second resin portions adjacent to each other in the stacking direction, among the plurality of the second resin portions.

According to the method for manufacturing an electrode assembly, the bag separator is used to effectively positon the first resin portion, the positive electrode, and the second resin portion, and further, the first resin portions of a pair that are arranged with the negative electrode interposed therebetween are welded together and the second resin portions of a pair that are arranged with the negative electrode interposed therebetween are welded together. Therefore, displacement of the positive electrode and the negative electrode from each other in the direction orthogonal to the stacking direction is suppressed.

### [Aspect 2]

The method for manufacturing an electrode assembly according to Aspect 1, wherein
in the first welding step, the first resin portions of the pair are welded together such that the first resin portions are in contact with the negative electrode, and
in the second welding step, the second resin portions of the pair are welded together such that the second resin portions are in contact with the negative electrode.

According to this aspect, displacement of the positive electrode and the negative electrode from each other in the direction orthogonal to the stacking direction is more reliably suppressed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A method for manufacturing an electrode assembly, the method comprising:
a stacking step of stacking a plurality of positive electrode units and a plurality of negative electrodes such that the positive electrode units alternate respectively with the negative electrodes, each of the plurality of positive electrode units including: a first resin portion; a second resin portion; a positive electrode located between the first resin portion and the second resin portion; and a bag separator formed in a bag shape with an opening and holding the first resin portion, the second resin portion, and the positive electrode in the bag separator;
a first cutting step of cutting a plurality of the first resin portions together with the bag separator along a stacking direction in which the positive electrode units and the negative electrodes are stacked, the plurality of the first resin portions being arranged in the stacking direction;
a second cutting step of cutting a plurality of the second resin portions together with the bag separator along the stacking direction, the plurality of the second resin portions being arranged in the stacking direction;
a first welding step of welding together a pair of the first resin portions adjacent to each other in the stacking direction, among the plurality of the first resin portions; and
a second welding step of welding together a pair of the second resin portions adjacent to each other in the stacking direction, among the plurality of the second resin portions.

2. The method for manufacturing an electrode assembly according to claim 1, wherein
in the first welding step, the first resin portions of the pair are welded together such that the first resin portions are in contact with the negative electrode, and
in the second welding step, the second resin portions of the pair are welded together such that the second resin portions are in contact with the negative electrode.
